(19) United States
(12) Patent Application Publication
(10) Pub. No.: US 2002/0069184 A1
(43) Pub. Date: Jun. 6, 2002

(54) Web-based transactional system

(76) Inventors: Mark Tilly, Scarborough, ME (US); Glenn J. Wira, Mount Laurel, NJ (US); A. Leigh Powell, Moorestown, NJ (US); Timothy Curran, Newton, MA (US)

Correspondence Address: LUCASH, GESMER & UPDEGROVE, LLP, 40 BROAD ST, SUITE 300, BOSTON, MA, 02109, US

(21) Appl. No.: 09/954,407

(22) Filed: Sep. 17, 2001

Related U.S. Application Data
(60) Provisional application No. 60/233,214, filed on Sep. 16, 2000.

(51) Int. Cl. G06F 17/60

(52) U.S. Cl. 705/80; 705/53

(57) ABSTRACT

A novel wide area-networked system and method allows users of a web site-based network to negotiate, modify and interpret the performance of complex agreements between network users via the web site. A web site host computer system provides contract templates governing the general type of contractual relations contemplated by the contractual parties, and allows direct negotiation between the users via the web site. Complex terms are allowable, including those that vary the price of goods and services over the course of a contract, such as volume discounts, rebates, and other incentives. The host computer system also serves to locate buyers and sellers with similar contractual interests and provides a history of previous network contracts to give potential buyers and sellers an idea of probable contractual terms when dealing with a prospective contractual party.

### INCORPORATION BY REFERENCE

This application is related to, and claims the priority of, commonly-owned United States provisional application for patent Serial No. 60/233,214 (identified by Attorney Docket: Imany/Webbased) filed Sep. 16, 2000, incorporated by reference herein in its entirety.

### FIELD OF THE INVENTION

The present invention broadly relates to electronic commerce (“e-commerce”) conducted via wide area networks such as the “Internet.” More particularly, the present invention relates to systems for allowing on-line parties to enter into contracts.

### BACKGROUND OF THE INVENTION

A “contract” has been defined as an agreement between two or more persons which creates an obligation to do or not to do a particular thing, and requires competent parties, subject matter, a legal consideration, mutuality of agreement, and mutuality of obligation. With the information age, there is now a previously unmet need to update the mechanisms for forming, modifying and interpreting contracts to be compatible with modem technology.

One example of a contract model that may still lead to widespread dissatisfaction involves the location and purchase of products through group purchasing organizations (GPOs) such as health care institutions. Health care institutions often enter into contracts with manufacturers that give them volume discounts for commonplace supplies. However, for low-volume or specialty products, a purchasing manager is often faced with the prospect of paying exorbitant prices, and delivery delays following long negotiation cycles necessitated by paper cycling between the contractual parties. Even worse, the purchasing manager may have no way to locate entities that can supply a particular product in time to meet the definite needs of clients such as doctors.

While prior art contractual formation approaches have used facsimile machines and electronic mail (“e-mail”) attachments as part of the negotiation process, it has been restricted to parties who have already established a certain level of communication or course of dealing.

As is well known, the Internet is a wide area network (WAN) allowing a vast number of remote terminal users to communicate with servers and other remote terminal users, and allows remote terminal users to retrieve web pages from the “World-Wide Web” (WWW). Communication between a user terminal and the WWW is typically through a web browser, a special interfacing server.

Communication with the web browser and web pages typically uses the Hypertext Transfer Protocol (HTTP) and the Hypertext Markup Language (HTML) as are known in the art. Network connections from a user to a web page of interest is made according to the Uniform Resource Locator (URL) of the particular web page.

Attempts to electronically form contracts via the Internet between parties with no course of dealings or communication has been limited to rudimentary contracts such as those covering auctions, where a product is placed in auction for sale, and those visiting the auctioneer's web site place bids.

It is desirable to eliminate paper trading and the delays and other deficiencies associated therewith during contractual formation, modification and monitoring of performance. It is also desirable to be able to conduct contractual negotiations, solicit sellers and buyers meeting specific requirements, modify and monitor performance with electronic means, where the terms are complex. Such complexities include price modifications during the course of the contract due to volume discounts, price rebates, product returns, and the like. Such complexities also include monitoring performance of contracts with respect to output or “requirements” terms. It is also desirable, but not practiced or suggested by the prior art, to conduct complex electronic contractual matters through an Internet portal by members of a network.

Finally, it is desirable, but not practiced or suggested by the prior art, to maintain records of contractual transactions of network members, available to allow potential buyers and sellers in the network to locate products and services of interest, as well as the probable terms that would be accepted in a contract.

### SUMMARY OF THE INVENTION

In view of the above-identified limitations of the prior art, the present invention provides a method of electronically forming or modifying agreements. The method at least includes the steps of, via a wide area network (WAN), providing host computing via a host computer system, the host computer system accessible via a web site, providing a network having a plurality each of buyers and sellers accessible by communication via the web site, and providing, via the host computer system, contract templates relating to predefined contractual types to network buyers and sellers interested in negotiating contracts governing contractual relations therebetween, and providing direct, electronic negotiation and mutual manifestation of assent between network buyers and sellers interested in negotiating contracts via the web site, including on-line modifications and counter-proposals. The terms of contracts formed using the method are not limited to auction bids and acceptances.

The present invention also provides a system for electronically forming or modifying agreements. The system at least includes a WAN, a host computer system accessible via a web site, and a network having a plurality each of buyers and sellers accessible by communication via the web site. The host computer system provides, via the web site, contract templates relating to predefined contractual types to network buyers and sellers interested in negotiating contracts governing contractual relations therebetween. The host computer system also provides direct, electronic negotiation and mutual manifestation of assent between network buyers and sellers interested in negotiating contracts via the web site, including on-line modifications and counter-proposals. And again, the terms of contracts formed using the method are not limited to auction bids and acceptances.

### BRIEF DESCRIPTION OF THE DRAWINGS

Features and advantages of the present invention will become apparent to those skilled in the art from the description below, with reference to the following drawing figures, in which:

FIG. 1 is a general schematic diagram of a system adapted for practicing the present-inventive comprehensive Internet contract negotiation, formation, and interpretation method; and

FIG. 2 is a flowchart detailing the operation of the present-inventive network with respect to the negotiation, formation and analysis of a contract.

### DETAILED DESCRIPTION OF THE INVENTION

The present invention is an application service provider solution to electronic negotiation, formation, modification, performance interpretation, and analysis of contracts. A network of users established by the application service provider communicates via the Internet through a portal web site. The back end computing architecture is responsible for tracking the products, previous and existing contracts of network users (and making this information available to other users in the network), as well as providing contract templates to parties interested in entering into contracts or contract negotiations.

In addition to connecting potential contracting parties via the web site, the back end is also responsible for, upon demand by users, analyzing existing or potential contractual terms regarding pricing or sales volume, inventory and the like. For example, a buyer is presented with the actual cost of goods contemplated when the seller has proposed to include rebates when certain target product volumes are met. Similarly, a supplier can view with greater clarity, the amount of charge-backs to which he or she is entitled upon distributing a certain level of goods.

In addition to providing comprehensive tools for the negotiation of contracts between users in contact with the web page, the present invention also provides analysis of current contracts of buyers and sellers so that the terms of performance such as actual money due or price or volume adjustments can be determined with specificity by the contractual parties to reduce potential disputes.

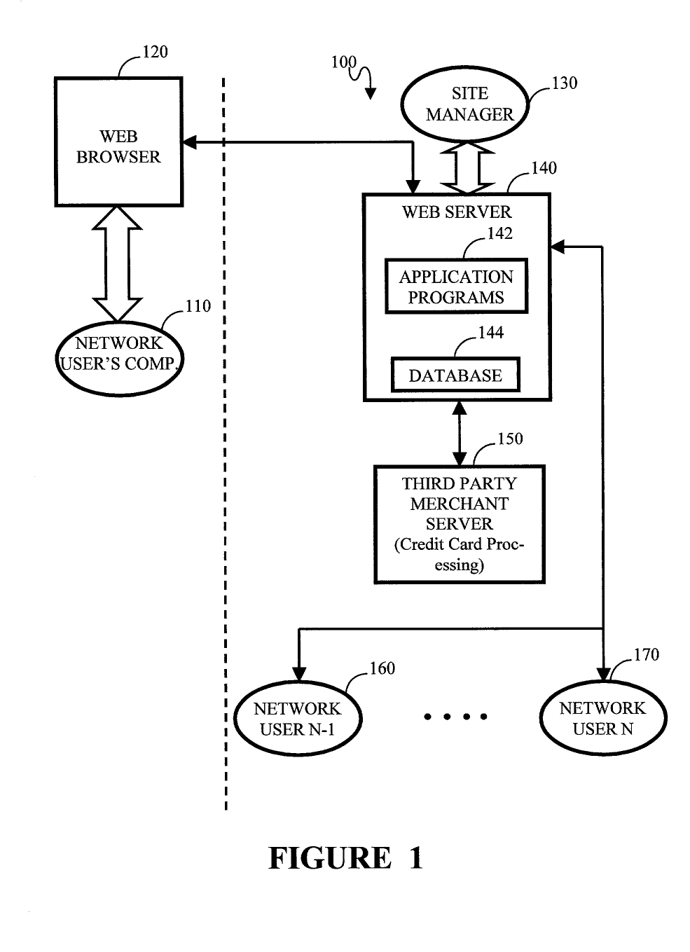

A general schematic block diagram of the present-inventive comprehensive Internet contract negotiation and management system 100 is shown in FIG. 1. The network 100 is capable of allowing an Internet user who is part of a network to indicate his or her desire to enter into a contract or contracts for the purchase of goods or services. As will be appreciated by those skilled in the art, the “user” may be an individual, as well as an entity such as a corporate buyer, distributor or manufacturer, for example. The network is administered by a site manager 130, who might generate income by charging access and transaction fees.

A user 110 desiring to purchase goods or services from other network users communicates on the World Wide Web via a web browser 120 as shown. The web browser locates the web domain (IP address) of a web page serving as a portal for the present-inventive contract network using an appropriate URL. In the preferred embodiment, the web page located is maintained by a powerful host computer system or web server 140 which handles back end processing for application service providing. The web server 140 contains a dynamically updated database 144 containing the product and service delivery capabilities of network users, as well as the particular contract requirements of the users. It also contains the contract history of the network users. The web server 140 also contains the application programs (142) needed for the electronic negotiation, formation and analysis of contracts via the network. These programs and the concomitant data include information necessary for presenting contract templates relating to particular transactions and contractual relations. Such templates might relate to contracts typical for the purchase and sale of medical supplies, or for the purchase and sale of food products, for example.

The web server 140 is under the control of the site manager 130 for management of the web server, updating of the database, and other functions such as facilitating e-commerce transactions as needed.

A separate third party server 150 handles the processing of credit cards and the like, as will be appreciated by those skilled in the art. Also shown in FIG. 1 is a symbolic representation (160, 170) of the multiple network users expected in such a network, with whom the initial user 110 might negotiate and form contracts.

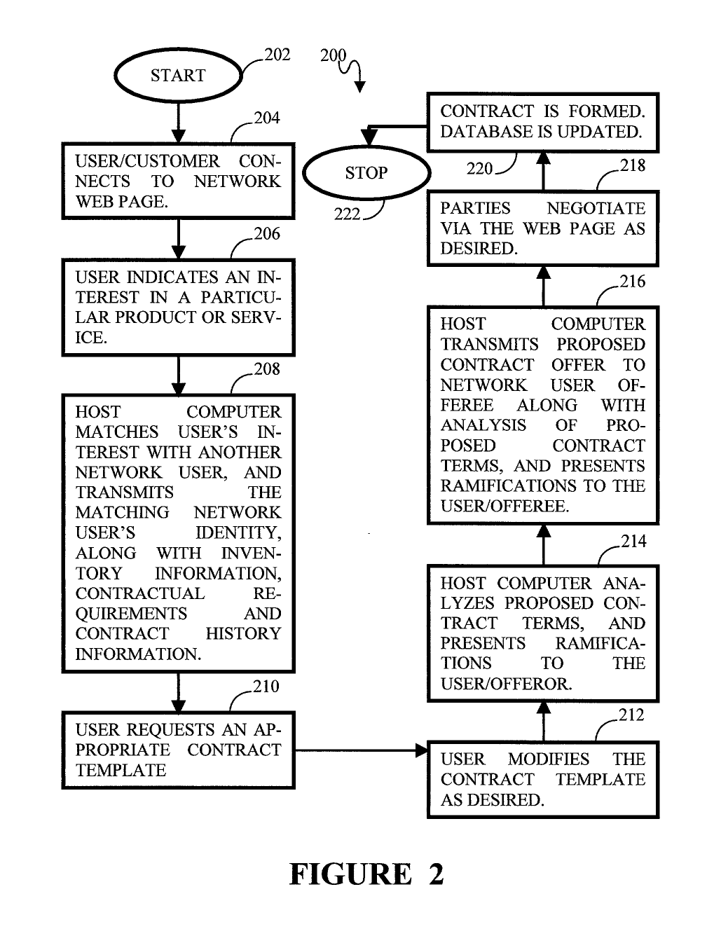

The basic contract negotiation process/algorithm 200 of the present invention is described below, with reference to FIG. 2.

After the start of the algorithm (Step 202), a user logs on to the web site maintained by the system 100 in Step 204. In Step 206, the logged-on user indicates that he or she (or it) is interested in buying or selling particular products or services, and indicates contractual terms such as price, volume, delivery dates, etc.

In Step 208, the host computer matches the user's requirements with those of other network users interested in buying or selling the products or services of interest identified in Step 206. This information is transmitted to the user (i.e., the identity of potential contract parties), including the relevant product or service delivery information received from the potential contract party, special requirements of the potential contract party, and network contract history information.

If the user desires to negotiate a contract with one of the other identified network users, an appropriate contract template is requested in Step 210. The user modifies the contract as desired in Step 212. In real time the host computer analyzes terms of the proposed contract—especially those related to price adjustments such as rebates and charge backs—so that the user will have a clear picture of the costs under the proposed contract (Step 214).

The host computer system transmits the proposed offer (which will form a contract if accepted) to the network user or users designated by the offeror user (Step 216). In the preferred embodiment, the host computer also analyzes the terms of the offer so that the offeree user will have a clear understanding of the financial and supply aspects of the contract.

The parties can then negotiate via the web page as desired (Step 218). In the preferred embodiment, the host computer system continues the real time analysis of the terms in offers (and counter-offers) for a better understanding of the terms by both parties. When mutual manifestation of assent and the other legal requirements for a contract are achieved, a contract is formed (Step 220). The extensive back end database is updated to include the new agreement for future use by the parties to the particular contract, and other network users who may desire dealings with the parties in the future. The algorithm ends in Step 222.

In an alternate embodiment, the parties can designate that the terms of the contract be kept confidential, and therefore not divulged to network users, although this is a matter of design choice.

Variations and modifications of the present invention are possible, given the above description. However, all variations and modifications which are obvious to those skilled in the art to which the present invention pertains are considered to be within the scope of the protection granted by this Letters Patent.

For example, the contracts managed by the present invention are not limited to any particular subject matter, type, or complexity. Similarly, the contract terms the back end system can analyze, are not limited to any particular type.

What is claimed is:

1. A method of electronically forming or modifying agreements comprising the steps of:
via a wide area network (WAN), providing host computing via a host computer system, said host computer system accessible via a web site;
providing a network having a plurality each of buyers and sellers accessible by communication via said web site;
providing, via said host computer system, contract templates relating to predefined contractual types to network buyers and sellers interested in negotiating contracts governing contractual relations therebetween;
providing direct, electronic negotiation and mutual manifestation of assent between network buyers and sellers interested in negotiating contracts via said web site, including on-line modifications and counter-proposals;
wherein the terms of contracts formed using said method are not limited to auction bids and acceptances.

2. The method in claim 1, wherein the terms of contracts formed using said method include price adjustments related to sales volume.

3. The method in claim 1, further comprising the steps of:
storing network user contract profiles; and
and broadcasting a relevant contract profile of a first network user upon request by a second network user indicating a desire to explore contractual relations with said first network user.

4. The method in claim 1, further comprising the steps of:
storing network user product availability statuses and projections; and
and broadcasting relevant product availability statuses and projections of a first network user upon request by a second network user indicating a desire to explore contractual relations with said first network user.

5. The method in claim 1, further comprising the steps of:
providing, via said host computer system, analysis of contract terms or proposed contract terms during negotiation or execution of contracts, upon request by a network party to contract or contract negotiations.

6. The method in claim 5, wherein contract terms analyzed include price of goods or services as a result of volume-related rebates.

7. The method in claim 5, wherein contract terms analyzed include price of goods or services as a result of volume-related charge-backs.

8. The method in claim 5, wherein contract terms analyzed include price of goods or services as a result of special promotions.

9. A system for electronically forming or modifying agreements comprising:
a wide area network (WAN);
a host computer system accessible via a web site; and
a network having a plurality each of buyers and sellers accessible by communication via said web site;
wherein said host computer system provides, via said web site, contract templates relating to predefined contractual types to network buyers and sellers interested in negotiating contracts governing contractual relations therebetween;
wherein said host computer system provides direct, electronic negotiation and mutual manifestation of assent between network buyers and sellers interested in negotiating contracts via said web site, including on-line modifications and counter-proposals; and
wherein the terms of contracts formed using said method are not limited to auction bids and acceptances.

10. The system in claim 9, wherein the terms of contracts formed using said method include price adjustments related to sales volume.

11. The system in claim 9, further comprising:
a user contract profile memory adapted to store network user contract profiles;
wherein said host computer system is adapted to broadcast a relevant contract profile of a first network user upon request by a second network user indicating a desire to explore contractual relations with said first network user.

12. The system in claim 9, further comprising:
a user product availability status and projection memory adapted to store network user product availability statuses and projections;
wherein said host computer system is adapted to broadcast relevant product availability statuses and projections of a first network user upon request by a second network user indicating a desire to explore contractual relations with said first network user.

13. The system in claim 9, wherein said host computer system is further adapted to provide analysis of contract terms or proposed contract terms during negotiation or execution of contracts, upon request by a network party to contract or contract negotiations.

14. The system in claim 13, wherein contract terms analyzed include price of goods or services as a result of volume-related rebates.

15. The system in claim 13, wherein contract terms analyzed include price of goods or services as a result of volume-related charge-backs.

16. The system in claim 13, wherein contract terms analyzed include price of goods or services as a result of special promotions.
